(19) United States
(12) Patent Application Publication
(10) Pub. No.: US 2026/0206782 A1
(43) Pub. Date: Jul. 23, 2026

(54) HEAT-TREATED BEVERAGE CONTAINING A FLUID GEL

(71) Applicant: SOCIÉTÉ DES PRODUITS NESTLÉ S.A., Vevey (CH)

(72) Inventors: Jean-Baptiste BEZELGUES, Lucens (CH); Adam BURBIDGE, Arzier (CH); Hans Jörg Werner LIMBACH, Epalinges (CH); Sarah MICHEL, Epalinges (CH); Hélène DEYBER, Jougne (FR); Patricia RAMOS MARTIN, Lausanne (CH)

(21) Appl. No.: 19/140,082

(22) PCT Filed: Dec. 13, 2023
(86) PCT No.: PCT/EP2023/085501

§ 371 Date: Jun. 17, 2025

(30) Foreign Application Priority Data
Dec. 20, 2022 (EP) 22214808.2

(51) Int. Cl. A23C 9/154; A23C 9/152; A23C 11/10; A23L 11/60; A23L 29/00; A23L 29/269

(52) U.S. Cl. CPC A23C 9/1544; A23C 9/1522; A23C 11/103; A23L 11/60; A23L 29/015; A23L 29/272

(57) ABSTRACT

The invention relates heat treated beverages containing fluid gels comprising particles formed from gellan and divalent cations, particularly calcium. The fluid gel beverage are surprisingly heat stable and maintain suspensive properties after heat treatment including UHT (ultra high temperature) heat treatment.

### TECHNICAL FIELD

The present invention relates generally to the field of beverages containing fluid gels that are stable under heat treatment such as UHT treatment. For example, the present invention relates to a heat-treated beverage containing a gellan based fluid gel with specific amounts of divalent cation such as calcium.

### BACKGROUND OF THE INVENTION

Fluid gels are suspensions of micro-particles formed of gelling polymers. Fluid gels are created when sufficient shear is applied to a gelling polymer solution during the gelation process. In the process to produce normal gels gelation occurs by allowing the solution to gel quiescently (i.e. without applying shear or other forces).

Fluid gels are defined by the presence of a suspension of microgel particles. Fluid gels possess different physical properties and dimensions to normal (quiescently formed) gels. For example, fluid gels can have properties resembling those of oil droplets in emulsion-based products (see for example Frith, W., Garijo, X., Foster, T., & Norton, I. (2002). Microstructural origins of the rheology of fluid gels. Special Publication-royal Society of Chemistry). On application of small stresses (steady or oscillatory) fluid gels deform in direct proportion to the stress in a similar way to quiescently formed gels. However, above a critical stress deformation of the fluid gel is replaced with viscous flows. This is contrary to quiescently formed gels which above critical stress shatter or break (see Morris et. al. “Gelation of gellan—A review”; Food Hydrocolloids; Volume 28, Issue 2, August 2012, Pages 373-411). Generally, quiescently formed gels have higher moduli (G′ and G″) than corresponding fluid gels (i.e., formed from the same gelling agent).

In view of their unique properties, there is a growing interest in the use of fluid gels in the food and beverage category. For example, fluid gels can be used as fat replacers as they produce creamy mouthfeel without the calories of full-fat products. Fluid gels can also be used to provide free flowing beverages with the ability to suspend particles within the beverage when at rest.

Fluid gels and methods to produce them are known. Fluid gels are generally produced by shearing gelling agents such as hydrocolloids during gelation. The particle size and structure of the fluid gel can be tailored by adapting the production techniques used as well as the gelling agent. For example, higher shearing rates tend to produce smaller particles.

Gelling agents such as gelling polysaccharides and gelling synthetic polymers (e.g. polymers produced synthetically from monomer polymerization reactions), are well known in the production of fluid gels. Gelling polysaccharides may be modified chemically or enzymatically modified (e.g. by de-acylation type reaction) although the polymer backbone is generally unchanged and corresponds to the naturally occurring gelling polysaccharide. Gelling polysaccharides are in general preferred to gelling synthetic polymers because they are derived from natural products and so are generally more acceptable for consumers and regulatory reasons.

Amongst others, polysaccharides that may be used to produce fluid gels include alginate, gellan, agar and carrageenan. Alginate is frequently used as alginate gels and alginate fluid gels are known to be stable to re-heating after formulation. Agar, carrageenan and gellan form heat-reversible gels upon cooling and are less preferred because they cannot be re-heated after formulation, as they melt back and lose their structure.

Heat-stability is a particularly desirable feature for ready to drink beverages where a pasteurization or UHT treatment step is required or desirable to improve shelf life such as for milk, fruit juice or dairy based products.

Pasteurization typically occurs at temperatures less than 100° C., typically from 80° C. to 100° C. for a longer period of time (compared to UHT), typically around 30 second to 10 minutes. UHT (ultra-high-temperature) treatments are typically carried out at higher temperatures, i.e. above 100° C., preferably above 135° C. for a shorter time period such as from 2 to 90 seconds.

Alginate has been studied as a heat-stable fluid gel. The heat-stability of alginate gels and fluid gels is well documented.

WO 2014/167373 A1 (Kraft Foods R&D inc.) relates to a method of making edible fluid gel particles for beverages. The alginate gel particles are made from alginate in the presence of calcium ions and are said to have small particle sizes. The alginate gel particles are intended to replace fats in hot drinks such as coffees and hot chocolates. The alginate gel particles are said to maintain their structure during heat treatment up to 130° C. WO2014/167373 A1 explains that such heat stability is not expected for thermoreversible gels such as those formed from gellan.

The amount of alginate used to produce heat stable fluid gels is relatively high, typically from 0.5 to 5 wt % is used depending on the type of alginate. In WO 2014/167373 A1, the amount of alginate in the examples is from 1 to 4% w/w.

Higher amounts of gelling agents can result in negative effects on sensory properties of consumer products, particularly beverages. For example, higher amounts of gelling agent can provide thick or sticky mouthfeel which is not appreciated by consumers in beverages such as cold drinks. Higher amounts of gelling agent can also cause sliminess or mouthcoating.

It would therefore be desirable to provide a beverage comprising a fluid gel that is stable to heat treatment, particularly to UHT treatment, with good sensory properties and the ability to suspend particles, such as solid inclusions.

It would also be desirable to provide a beverage comprising a fluid gel prepared with gelling agent(s) derived from natural sources and/or that it is prepared with a low amount of gelling agent and/or with a limited number of gelling agent(s).

Any reference to prior art documents in this specification is not to be considered an admission that such prior art is widely known or forms part of the common general knowledge in the field.

### SUMMARY OF THE INVENTION

The object of the present invention is to improve the state of the art, and in particular to provide a beverage comprising a fluid gel that overcomes the problems of the prior art and addresses the needs described above, or at least to provide a useful alternative. In particular, one object of the invention may be to provide a beverage comprising a fluid gel that is stable under pasteurisation and UHT conditions whilst maintaining acceptable sensory properties.

The inventors were surprised to see that the object of the present invention could be achieved by the subject matter of the independent claims. The dependent claims further develop the idea of the present invention.

Accordingly, the invention provides a heat-treated beverage comprising a fluid gel comprising particles formed of gellan and a divalent cation such as a divalent metal cation. The divalent cation is present in 0.001 to 0.1 wt % based on total weight of the beverage. The fluid gel comprising particles formed of gellan and the divalent cation is present before and after the heat treatment. The heat-treated beverage is a long-life or shelf stable beverage.

The invention also provides a process to produce a beverage of the invention. The process to produce a heat-treated beverage comprising a fluid gel comprising the steps (preferably in order) of:
1. providing a heated beverage mixture comprising gellan, divalent cation and an aqueous liquid, wherein the beverage mixture comprises 0.001 to 0.1 wt % divalent cation based on total weight of the beverage,
2. cooling while shearing the heated beverage mixture to form a cooled beverage comprising a fluid gel comprising particles formed of the gellan and the divalent cation,
3. heat-treating the cooled beverage comprising a fluid gel to obtain a heat-treated beverage comprising a fluid gel.

Surprisingly and unexpectedly, fluid gels formed of gellan with certain amounts of divalent cations such as calcium ions have been found to be stable to heat treatment, including UHT treatment. The term ‘stable’ used herein refers to the ability of the fluid gel to retain specific properties during and after heat treatment such as the ability to suspend particles, e.g. solid inclusions.

Gellan fluid gels have been shown to be sufficiently strong that they can suspend particles, such as solid inclusions, even at low concentrations, even after heat-treatment. In this way, the invention provides heat treated beverages (i.e. long life beverages) that are capable of suspending particles, such as solid inclusions with modifiable and good sensory properties.

The gellan fluid gels maintain acceptable sensory properties, in particular for beverage applications, even after heat-treatment.

These and other aspects, features and advantages of the invention will become more apparent to those skilled in the art from the detailed description of embodiments of the invention, in connection with the attached drawings.

### BRIEF DESCRIPTION OF THE DRAWINGS

FIG. 1 shows data of gellan fluid gels produced using different shearing heads. FIG. 1A shows the PhiTau values for different shearing heads. FIG. 1B shows pictures of the different shearing heads along with microscopic images of the fluid gel particles. The shearing head labelled ‘0’ is the paddle in FIG. 1A. Shearing head ‘1’ in FIG. 1B corresponds to S1 in FIG. 1A, shearing head ‘2’ in FIG. 1B corresponds to S2 in FIG. 1A and so on. These are the results of the experiments in Example 2.

FIG. 2 shows a graph of PhiTau vs calcium concentration for gellan and alginate fluid gels produced in Example 3.

FIG. 3 shows a graph of PhiTau vs pH for gellan and alginate fluid gels produced in Example 4.

FIG. 4 shows graphs of viscosity vs gelling compound concentration before and after pasteurisation treatment. FIG. 4A shows the results for a gellan fluid gel at various concentrations before and after pasteurisation treatment. FIG. 4B shows the results for an alginate fluid gel at various concentration before and after pasteurisation treatment. These are the results of the experiments in Example 5.

FIG. 5 shows BRUCE analysis of gellan and alginate fluid gels before and after pasteurisation treatment. FIG. 5A shows the results for a gellan fluid gel before and after pasteurisation treatment. The PhiTau value of the gellan fluid gel is 15.0 Pa before pasteurisation and 12.1 Pa after pasteurisation. FIG. 5B shows the results for an alginate fluid gel before and after pasteurisation treatment. The PhiTau value of the alginate fluid gel is 7.8 Pa before pasteurisation and 7.8 Pa after pasteurisation. These are the results of the experiments in Example 5.

FIG. 6 shows graphs of viscosity vs shear rate for fluid gels before and after UHT heat treatment. FIG. 6A shows the results for a gellan fluid gel before and after UHT treatment. FIG. 6B shows the results for an alginate fluid gel before and after UHT treatment. These are the results of the experiments in Example 5.

FIG. 7 shows BRUCE analysis of gellan and alginate fluid gels before and after UHT treatment. FIG. 7A shows the results for a gellan fluid gel before and after UHT treatment. The PhiTau value of the gellan fluid gel is 21.8 Pa before UHT and 16.9 Pa after UHT. FIG. 7B shows the results for an alginate fluid gel before and after UHT treatment. The PhiTau value of the alginate fluid gel is 5.4 Pa before UHT and 4.0 Pa after UHT. FIG. 7C shows results for gellan fluid gels made with high (0.3 wt % calcium chloride 1M) and low (0.01 wt % calcium chloride 1M). The PhiTau value of the ‘low’ calcium gellan fluid gel is 8.6 Pa before UHT and 20.4 Pa after UHT. The PhiTau value of the ‘high’ calcium gellan fluid gel is 17.7 Pa before UHT and 10.9 Pa after UHT. These are the results of the experiments in Example 5.

FIG. 8 shows a DSC trace for a gellan fluid gel prepared in Example 5.

FIG. 9 shows microscopy images of gellan fluid gels before and after various heat treatments. FIG. 9A shows images before and after pasteurisation treatment. The different pictures in each column relate to different regions of the same sample. FIG. 9B show image before and after UHT treatment. The left hand images in FIG. 9B are before UHT treatment and the different pictures in each column relate to different regions of the same sample. The right hand images in FIG. 9B are after UHT treatment and the different pictures in each column relate to different regions of the same sample. These are the results of the experiments in Example 5.

FIG. 10 shows a graph of the sensory data produced in Example 6. Specifically the graph shows the thickness perception as measured by panel testing for various compositions of the invention and comparative example. The results show that gellan fluid gels are perceived as thicker than water, but less than a set gellan gel broken down into pieces afterwards or less than xanthan.

FIG. 11 shows a graph of viscosity vs shear rate for a gellan fluid gel prepared in milk before and after UHT heat treatment. These are the results of the experiments in Example 7.

FIG. 12 shows a graph of viscosity vs shear rate for a gellan fluid gel prepared in milk at low gellan concentration before and after UHT treatment. These are the results of the experiments in Example 7.

FIG. 13 show graphs of viscosity for two different compositions before and after heat treatment and then after 6 and 10 days storage. FIG. 13A shows the results for a fluid gel beverage of the invention made by adding gellan to milk. FIG. 13B are the results for fluid gel beverage of the invention made by adding gellan and calcium to milk. These are the results of the experiments in Example 8.

FIG. 14 shows images of various beverages containing particles. In FIG. 14A, the right hand images show a heat-treated beverage containing gellan fluid gels of the invention and the left hand image shows a comparative beverage without the fluid gel. The images show that the beverage of the invention containing a gellan fluid gels can suspend pieces of fruit (strawberries, blueberries and raspberries) after heat treatment whereas a beverage without the fluid gel cannot. FIG. 14B provides further examples of different particulate matter (lime slices as well as the fruit pieces in FIG. 14A) that can be suspended in the heat-treated beverages of the invention. The fluid gel composition in FIGS. 14A and 14B is 0.1% gellan+0.05% CaCl₂.

FIG. 15 shows results for the experiments in Example 9.

FIG. 16 shows microscopy images of the ‘low’ and ‘high’ calcium containing gellan fluid gels produced in Example 5 before and after various heat treatments. FIG. 16A shows images before and after UHT treatment for ‘low’ calcium gellan fluid gel. FIG. 16B shows images before and after UHT treatment for ‘high’ calcium gellan fluid gel. The different pictures in each column relate to different regions of the same sample.

FIG. 17 shows sensory data produced in Example 7.

### DETAILED DESCRIPTION OF THE INVENTION

As used in the specification, the words “comprise”, “comprising” and the like are to be construed in an inclusive sense, that is to say, in the sense of “including, but not limited to”, as opposed to an exclusive or exhaustive sense.

As used in the specification, the word “about” should be understood to apply to each bound in a range of numerals. Moreover, all numerical ranges should be understood to include each whole integer within the range where appropriate (for example where the range relates to a discrete feature for which only integer values are appropriate) and to include all intermediate values where appropriate (for example where the range relates to a continuous feature where all intermediate values are possible).

As used in the specification, the singular forms “a”, “an”, and “the” include plural referents unless the context clearly dictates otherwise.

As used in the specification, the term “substantially free” means that no more than 10 weight percent, preferably no more than 5 weight percent, and more preferably no more than 1 weight percent of the excluded material is present. In a preferred embodiment, “substantially free” means that no more than 0.1 weight percent of the excluded material remains. “Entirely free” typically means that at most only trace amount of the excluded material is present, and preferably, no detectable amount is present.

As used in the specification, the term “has a shelf life at least 2 months” means that the heat-treated beverage does not spoil over 2 months of storage under ambient and/or refrigeration conditions.

As used in the specification, the term “plant-based milk alternative” refers to a food product which comprises ingredients of plant origin, which is free from dairy and which has qualities as to appearance, and texture as the corresponding real dairy milk. Preferably, the milk analogue is exclusively made from vegan ingredients.

As used herein, the term “vegetarian” refers to an edible composition which is devoid of meat, including fish.

As used herein, the term “vegan” refers to an edible composition which is entirely devoid of animal products, or animal derived products.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

The invention provides a heat-treated beverage comprising a fluid gel comprising particles formed of gellan and a divalent cation such as a divalent metal cation. The divalent cation is present in 0.001 to 0.1 wt % based on total weight of the beverage. The fluid gel comprising particles formed of gellan and the divalent cation is present before and after the heat treatment. The heat-treated beverage is a shelf stable beverage.

By “shelf stable” it is understood that the heat-treated beverage has a shelf-life of at least 1 week, such as at least 1 month, such as at least 3 months, or at least 6 months, preferably from 1 to 12 months, more preferably from 3 to 12 month, even more preferably from 6 to 12 months when stored under storage conditions such as ambient conditions and/or refrigeration conditions, preferably the heat-treated beverage has a shelf life as above when stored under ambient conditions. The term “ambient conditions” refers to temperatures ranging from 15° C. to 25° C., preferably from 20° C. to 22° C. and, in particular, pressure of about 1 atmosphere. The term “refrigeration conditions” refers to temperatures ranging from 0° C. to 15° C., preferably from 1° C. to 5° C. and in particular pressure of about 1 atmosphere. These storage temperatures relate to the storage of the composition before being commercially obtained by an end consumer. Generally, the end consumer is advised to store the composition under the same conditions until consumption, for example on a shelf at room temperature and pressure. In some cases, the term ‘long life’ is also used to refer to ‘shelf stable’ beverages. “Shelf stable” used herein may also refer to the property that the heat-treated beverage is stable upon storage as outlined above for example, the beverage maintains the ability to suspend particles such as solid inclusions during storage.

The heat-treated beverage may be a dairy beverage, plant-based dairy beverage alternative, coffee beverage, cocoa beverage, malted beverage, tea, juice, soft drink or a mixture thereof.

A heat-treated beverage refers to a beverage that has undergone a heat treatment process such as pasteurisation or UHT treatment to prolong the shelf life of the beverage. The heat treatment may be carried out at 80° C. or more such as 90° C. or more and preferably 100° C. or more and preferably 120° C. or more. The heat treatment may be carried out at 160° C. or less, such as 150° C. or less and preferably 140° C. or less. The heat treatment may be carried out within a range of temperatures taken from the upper and lower limits above. For example, the heat treatment may be carried out at from 80 to 160° C., preferably from 100 to 140° C.

The fluid gels used in the beverage are stable when subjected to heat treatment. That is, the fluid gel comprising particles formed of gellan and the divalent cation is present in the beverage before and after heat treatment. The fluid gel formed of gellan survives the heat treatment process to provide the heat-treated beverage of the invention. In some cases, the physical properties of the gellan based fluid gel may be substantially the same before and after heat treatment.

In this way, the present invention provides at least an alternative fluid gel (to the prior art heat resistant alginate fluid gels) that is capable of being heat treated, such as UHT treated, without significantly impacting the fluid gel properties.

The present invention also provides a fluid gel beverage that is heat stable and can suspend particles such as solid inclusions even at low concentrations of gelling agents. The ability to use a range of amounts of gelling agent (including lower amounts) means the beverages of the invention can have their sensory properties tailored to suit a particular use. It also allows the use of less gelling agent.

The invention also provides a process to produce a heat-treated beverage comprising a fluid gel comprising the steps of:
providing a beverage mixture comprising gellan, divalent cation and an aqueous liquid, wherein the beverage mixture comprises 0.001 to 0.1 wt % divalent cation based on total weight of the beverage,
heating the beverage mixture to obtain a heat-treated beverage mixture,
cooling while shearing the heat-treated beverage mixture to form beverage comprising a fluid gel formed of the gellan and the divalent cation,
heat-treating the beverage comprising a fluid gel to obtain a heat-treated beverage comprising a fluid gel.

Gellan is well known as a gelling agent and has also been studied for its fluid gel formation ability. Gellan fluid gels in general are discussed in Sworn et. al. (“Gellan gum fluid gels; Food hydrocolloids, Vol. 9, no. 4, pp 265 to 271). Sworn et. al. look at the properties of gellan fluid gels. The test solutions used in the studies are made using a rheometer. Fluid gels are formed with 0.125 wt % gellan in the absence of any cation, with sodium and with calcium. There is no heat treatment of these test solutions after the fluid gel is formed in Sworn and no discussion at all of heat treatment or heat resistance of the fluid gel. Generally, gellan is considered to be unstable to heat and the gel structure is known to be destroyed on heating (see WO 2014/167373 A1 and Gelation of Gellan—A review, Food Hydrocolloids, Vol. 28, Issue 2, pp 373 to 411 at least).

Surprisingly and unexpectedly the gellan fluid gels in the heat-treated beverages of the invention have been shown to have stability during pasteurisation and UHT treatment. Stability here refers to the preservation of one or more property before and after heating, in particular to the preservation of the ability to suspend particles such as solid inclusions. Further, the gellan fluid gels of invention have been shown to be more stable than corresponding alginate fluid gels prepared at similar concentration.

The use of gellan for forming the fluid gels of the invention provides more controlled formulation compared to alginate which is known to react quickly and generate irregular particles.

The fluid gels of the beverage of the invention also provides the advantage that lower amounts of gelling agent can be used and still achieve the desired suspension properties. As a result, the viscosity of the overall beverage can be adjusted to suit the end user and to aid in the manufacturing process.

The heat-treated beverage contains an aqueous liquid. The aqueous liquid may be selected from the list consisting of water, coffee, tea, cocoa-based drinks such as hot chocolate, malt-based drinks, fruit juice, vegetable juice, milk, plant-based milk alternative, soup or a mixture thereof. The heat-treated beverage of the invention may comprise any other components that are well known for beverages. For example, the heat-treated beverage of the invention may comprise minerals, salts, buffering salts, flavourants, colourants, carbohydrates, fats, proteins, preservatives, stabilisers, probiotics, prebiotics, vitamins. The carbohydrates include sugars, sweeteners and fibers.

The heat-treated beverage of the invention may further comprise solid inclusions. The solid inclusions are compounds which are immiscible with the heat-treated beverage and which, when they are dispersed in the form of particles in the heat-treated beverage, remain visible to the naked eye. These solid inclusions are suspended, preferably homogeneously, in the heat-treated beverage. The solid inclusions may be chocolate chips, citrus zest, fruit pieces, vegetable pieces, candied fruits, dried fruits, confectionery pieces, spices, nuts, vanilla grains, ground vanilla pods, tapioca balls, polysaccharides-based beads or a mixture thereof. Examples of polysaccharides-based beads include alginate beads. The solid inclusions may be particulate matter such as sediments for example cocoa powder.

### Fluid Gel

The heat-treated beverage of the present invention comprises a fluid gel comprising particles formed of gellan and 0.001 to 0.1 wt % of a divalent cation based on total weight of the beverage.

In some cases, the particles fill from 25 to 75%, preferably from 40 to 60% such as about 50% of the total volume of the beverage.

In some cases, the concentration of gellan in the particles is from 1 to 3 times the concentration of gellan in the beverage. For example, the concentration of gellan in the particles is around 2 times the concentration of gellan in the beverage.

The term fluid gel as used herein refers to a gel that flows when poured and holds itself together at rest. A fluid gel is a composition in which the bulk shear properties of the effective medium (i.e. the gel suspension), are different to those of the individual microgel particles, specifically the elastic and yield stress properties. These fluid gel properties can be determined by Atomic Force Microscopy (AFM) or the BRUCE method described herein. For example, fluid gels can be identified on the basis that a BRUCE shear yield stress will give a different value to the shear yield stress measured in bulk shear rheometry. The BRUCE shear yield can be measured as outlined in the experimental section using routine techniques known to the skilled person.

“Bulk shear rheometry” used here refers to standard rheometry techniques that are known in the field for measuring shear yield stress. For example, the shear yield stress can be measured using bulk shear rheometry by carrying out a strain-sweep test with strain from 0.1 to 1000% at 1 Hz, measured at 20° C. using an Anton Paar Rheometer, MCR series, with a CC27 Sanded geometry.

Fluid gels are formed by application of a sufficiently energetic flow field, such as by shearing, to the gelling agent in solution whilst undergoing conformational transition and consequent aggregation i.e. during setting of the gel. Typically, the flow field is applied using a rheometer or shear mixer during the cooling process. Fluid gels can be referred to as structured liquids or weak gels. Fluid gels can be described as wet, sot granular material or soft microgel particle suspensions. Fluid gels comprise particles formed of the gelling substance (e.g. gellan) suspended in a bulk solvent phase such as an aqueous liquid. The gel particles provide the structural properties of fluid gels.

The fluid gel of the beverage of the invention comprises particles formed from gellan and divalent cations such as calcium. That is, the particles of the fluid gel are composed of gellan polysaccharide chains cross-linked together by the divalent cations such as calcium.

The fluid gel beverages of the invention may have a balance of properties. The balance of properties may provide the beverage with the desired characteristics. The desired characteristics will be determined by the type of beverage. For example, in some beverages the desired characteristics may include being poorable/drinkable, the ability to suspend solid particles and a clean mouth feel (e.g. no particles felt), and a viscosity that is low enough to be palatable (e.g. no thicker than a smoothie).

In some embodiments, the beverage of the invention has a pH of at least 3, for example at least 3.5, preferably at least 4. In some embodiments, the beverage of the invention has a pH of from 3 to 8, for example from 3.5 to 7 and preferably of from 4 to 7. pH may be measured using a pH probe at 20° C. The pH probe may be a handheld pH probe with a gel electrolyte such as a Ph110 pH meter from VWR. The pH probe may be calibrated the same day. The pH may be measured after full solubilisation of the hydrocolloid.

Without wishing to be bound by theory, it is proposed that the pH of the beverage may affect the binding between the gellan and the divalent cation and so effect the fluid gel properties. The pH is preferably chosen to provide optimum properties such as in terms of calcium binding, viscosity and/or the ability to suspend particles in the beverage, even after a heat treatment.

In some embodiments, the particles formed of gellan and divalent cations in the fluid gel have a particle size of 10 to 1000 μm such as from 20 to 500 μm, preferably from 30 to 100 μm.

The particle size as used herein refers to a volume mean average particle size. Particle size may be measured by microscopy and visual inspection. For example, a microscopy image may be taken using a Axioplan microscope. The largest dimension of 2-5 particles in the image is determined by eye using a scale bar and a mean average is calculated. The images may be stained before analysis, for example may be stained by toluidine blue.

The particles of the fluid gel have a range of sizes (i.e. they are not completely uniform or identical in size). In some embodiments, the particle size of the particles of the fluid gel discussed above refers to a volume-based particle size from d10 to d90. That is, the particle sizes above are the sizes of the particles between the 10^{th} (i.e. d10) and 90^{th} (i.e. d90) percentiles of the overall particle size distribution.

Fluid gels with the particle sizes mentioned can be prepared by adjusting the production parameters as is well known in the field. For example, it is well known that the cooling rate, shear speed and paddle type affect the particle size and distribution of a fluid gel. In particular, for the preferred particle sizes, a mixer capable of high shearing rates can be used to produce the desired fluid gel. Suitable mixers include Ystral mixer, Mondomix Pin Stirrer, Silverson LSM-A. Fluid gels made using a rheometer have larger particle sizes such as greater than 500 μm.

In this way, the beverages of the invention have good thermal stability properties for heat treatment in combination with good sensory properties and can be produced on an industrial scale.

The viscosity of a fluid gel beverage varies depending on the shear rate. At low shear the viscosity of a fluid gel may be relatively high and at high shear the viscosity is much lower. In this way, when a fluid gel beverage is at rest (e.g. low shear) the fluid gel beverage has the ability to support particles and when the fluid gel beverage is being consumed (e.g. high shear) the fluid gel beverage pours and behaves as a normal beverage.

In one embodiment, the fluid gel beverage has a viscosity in a steady shear measurement of at least 10, at least 100, at least 500, preferably at least 1,000 mPa·s measured at a shear rate of 0.1 1/s.

In one embodiment, the fluid gel beverage has a viscosity in a steady shear measurement of at most 30,000, at most 20,000, preferably at most 10,000 mPa·s measured at a shear rate of 0.1 1/s.

In one embodiment, the fluid gel beverage has a viscosity in the range 100 to 15,000 mPa·s, such as 1,000 to 10,000 mPa·s measured at a shear rate of 0.1 1/s.

In one embodiment, the fluid gel beverage has a viscosity in a steady shear measurement of at least 1, at least 5, preferably at least 10 mPa·s measured at a shear rate of 100 1/s.

In one embodiment, the fluid gel beverage has a viscosity in a steady shear measurement of at most 1000, at most 500, preferably at most 100 mPa·s measured at a shear rate of 100 1/s.

In one embodiment, the fluid gel beverage has a viscosity in the range 1 to 1000 mPa·s, such as 10 to 1000 mPa·s measured at a shear rate of 100 1/s. The viscosities discussed here may refer to the viscosity of the heat-treated beverage after heat treatment.

In one embodiment, the fluid gel beverage has a viscosity at 0.1/s and a viscosity at 100 1/s as defined above. In particular the fluid gel beverage has a viscosity in the range 1,000 to 10,000 mPa·s measured at a shear rate of 0.1 1/s and the fluid gel beverage has a viscosity in the range 10 to 100 mPa·s measured at a shear rate of 100 1/s.

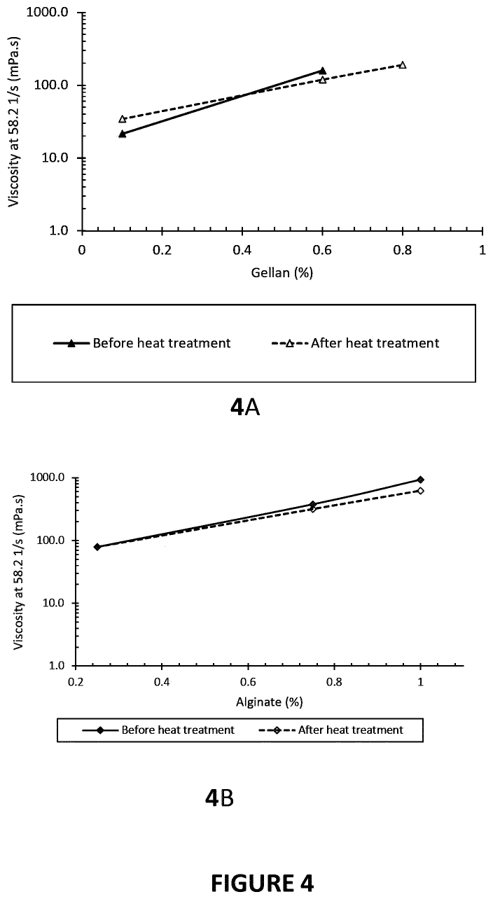

The viscosities discussed herein may refer to the viscosity of the heat-treated beverage after heat treatment. The viscosity value may be the value recorded at 20° C. in a steady shear measurement. For example, the viscosity may be measured using an Anton Paar Rheometer, MCR series, with a CC27 Sanded geometry. The shear rate applied may start from 0.01 to 300 s−1 and points may be recorded at a rate of 10 pts/decade. Such measurements are described in the worked examples of the present case, and exemplary results are set out in FIGS. 4, 6, 11 and 12

In one embodiment, the fluid gel beverage has a PhiTau value of at least 4 Pa, for example at least 10 Pa and preferably at least 20 Pa.

In one embodiment, the fluid gel beverage has a PhiTau value of at most 100 Pa, for example at most 75 Pa and preferably at most 60 Pa

In some embodiments, the PhiTau value of the fluid gel beverage is within a range taken from any of the upper and lower limits described above. For example, the PhiTau value of the fluid gel beverage may be from 10 to 75 Pa, preferably from 20 to 60 Pa.

The term “PhiTau” as used herein is as shorthand term for a compound parameter made up of the yield stress (Tau) and the packing fraction (Phi). Specifically, PhiTau is used to refer to the parameter:

2×Phi^{(2/3)}×Tau

Tau is the shear yield stress and Phi is the bulk volume fraction of gel particles.

PhiTau provides a quantitative measure of the ability of a fluid gel to support particles at a given concentration. Higher PhiTau values indicates a fluid gel that is more able to support particles.

PhiTau can be measured by the BRUCE method as outlined in detail in the examples section. Preferably, PhiTau is measured at 20° C. Traditional shear rheometry processes when applied to fluid gels measures the (weaker) stresses between discrete fluid gel particles. This is because the fluid gel particles can roll relative to each other without deforming in this type of shear experiment. The BRUCE method measures the true yield stress of the fluid gel particles which are destroyed in the measurement process.

For normal continuous gels (e.g. those produced under quiescent condition), where there are no particles, the shear yield stress measurement carried out using bulk shear rheometry (described above) should provide the same Tau value as the measurements provided by BRUCE method. For fluid gels, the shear yield stress (Tau) values will be different using the bulk shear rheometry and BRUCE measurements because they are measuring different physical properties. To obtain the Tau value from the BRUCE measurement, the Phi value is estimated based on the powder packing literature at about 50% packing. Alternatively, Tau for a fluid gel can be directly obtained in Atomic Force Microscopy (AFM).

A high PhiTau value (e.g. 10 to 75 Pa, preferably from 20 to 60 Pa), a low viscosity at rest (e.g. 1,000 to 10,000 mPa·s measured at a shear rate of 0.11/s) and a high viscosity when poured (e.g. 10 to 100 mPa·s measured at a shear rate of 100 1/s) are a preferred combination of physical properties for beverage products containing fluid gels.

### Gellan

The beverage of the present invention comprises a fluid gel comprising particles formed from gellan.

Gellan, as referred to as gellan gum, refers to products derived from the extracellular polysaccharide produced by fermentation of the organism Sphyngomona (formerly Pseudomonas) elodea. The polysaccharide that forms the basis of gellan has a repeat unit which consists of two residues of D-glucose and one of each residue of L-rhamnose and D-glucuronic acid. Gellan products can be prepared by chemically modifying the polysaccharide produced by fermentation such as by diacylation of side chains. Generally chemical modification affects side chain groups and the polysaccharide back bone remain intact. Gellan products are generally put into two categories, low acyl and high acyl depending on number of acetate groups attached to the polymer.

Gellan is also known as Gellan Gum. Gellan may be referred to as E418 (European food standards additive number) or [D-Glc(β1→4)D-GlcA(β1→4)D-Glc(β1→4)L-Rha(α1→3)]ₙ.

In some embodiment, the gellan is divalent cation-sensitive gellan. By “divalent cation-sensitive gellan”, it is understood a gellan whose gelling is modulated and/or induced by the presence of divalent cation, in particular divalent cation as disclosed herein.

In some embodiment, the gellan used in the invention is a low acyl gellan. For example, the gellan may have less than 50% acylation, preferably less than 25% acylation. In some embodiment, the gellan has more than 1% acylation, preferably more than 10% acylation. The acylation of the gellan may be within a range taken from the upper and lower limits above. For example, the gellan may have an acylation of from 1 to 50%, preferably from 10 to 25%.

In this way, the crosslinking of gellan with the divalent cation such as calcium may be increased, and the temperature resistance may be improved.

In some embodiments, the gellan has a molecular weight, such as an average molecular weight of 100,000 to 500,000 Da, preferably from 200,000 to 300,000 Da.

In some embodiment, the concentration of gellan in the beverage is at most 1.0 wt %, for example at most 0.8 wt %, for example at most 0.6 wt %, for example at most 0.15 wt %, for example at most 0.12 wt %, for example at most 0.11 wt % and preferably at most 0.10 wt % based on the total weight of the beverage.

In some embodiments, the concentration of gellan in the beverage is at least 0.01 wt %, for example at least 0.03 wt %, for example at least 0.04 wt %, for example at least 0.08 wt % and preferably at least 0.05 wt % based on the total weight of the beverage.

In some embodiments, the concentration of gellan in the beverage is within a range taken from any of the upper and lower limits described above. For example, the amount of gellan in the beverage may be from 0.05 to 0.5 wt %, such as from 0.08 to 0.11 wt % and preferably from 0.04 to 0.11 wt % based on the total weight of the beverage.

The concentration of gellan can be used to adjust the properties of the beverage. For example, at higher concentrations, higher viscosity of the bulk solvent phase may be provided due to the thickening effect of free gellan and may be harder to shear in order to produce the fluid gel. It is desirable to be able to use variable amounts of gellan (or any gelling agent) and still provide the beneficial properties (e.g. particle or solid inclusion suspension ability, good sensory properties) as this allows the use of an amount suitable for providing the desired viscosity to the end product. For example, the prior art UHT stable alginate fluid gels have much higher concentration (around 1-4 wt % alginate) which results in more viscous beverages and so has limited utility (i.e. limited to beverages intended to be viscous) and not optimal sensory properties.

In this way, it is proposed that the concentration ranges above provide beverages with sufficient yield stress properties for suspension of particles whilst also limiting the viscosity such that the beverage has the desired flowing consistency when shear is applied (e.g. by pouring).

The fluid gel of the beverage of the invention comprises particles formed of gellan and divalent cations. In some cases, the fluid gel particles may also be formed of additional components such as other gelling agents or aqueous liquids. That is, the fluid gel particles may be formed of gellan, divalent cations and other components.

In some embodiments, the fluid gel particles consist entirely of gellan and the divalent cation. That is, the fluid gel particles are formed solely from gellan and the divalent cation. Put another way, the fluid gel particles are substantially free from any other gelling agent different from gellan. Preferably, the fluid gel particles are entirely free from any other gelling agent different from gellan. For examples, the fluid gel particles do not comprise any of the following gelling agents: xanthan gum, alginate, agar, carrageenan, furcellaran, colloidal microcrystalline cellulose (colloidal MCC), tamarind seed gum, locust bean gum (LBG), tragacanth gum, pectin, konjac, curdlan, guar gum and gelatin.

The fluid gel particles may not comprise any of these other gelling agents different from gellan. However, gelling agents different from gellan may be present in the bulk beverage for example to act as thickeners or to provide solid inclusions (e.g. alginate beads). In an embodiment, the heat-treated beverage is substantially free from any of these other gelling agents different from gellan, preferably the heat-treated beverage is entirely free from any of these other gelling agents different from gellan.

### Cation

The beverage of the invention comprises a fluid gel containing divalent cations in from 0.001 to 0.1 wt % based on total weight of the beverage.

Without wishing to be bound by theory, it is proposed that the divalent cations act to cross link the gellan polymer chains to provide microgel particles in solution. In particular, it is proposed that divalent cations stabilise gellan by adding electrostatic stabilisation to the folded helices. It is also considered that the inclusion of some divalent cations allows lower concentrations of gellan to form fluid gels than is possible for gellan alone.

The term divalent cation refers to a positively charged species with a 2+ charge.

In some embodiments the divalent cation may be a divalent metal cation. In some embodiments, the divalent metal cation is selected from calcium, magnesium, zinc, copper, iron, or a mixture thereof. Preferably, the divalent metal cation is calcium (Ca²⁺).

In some embodiments, the divalent metal cation is provided by the addition of a metal salt. Preferably, the metal salt is soluble. Examples of soluble metal salts include calcium chloride hydrate (i.e. CaCl₂·(H₂O)ₙ where n is from 1 to 5, preferably n is 2), calcium acetate hydrate (i.e. CaOAc·H₂O), calcium lactate hydrate (e.g. pentahydrate), calcium glycerophosphate, tricalcium citrate tetrahydrate, or calcium sulfate. Preferably, the metal salt is selected from calcium chloride hydrate (i.e. CaCl₂·(H₂O)ₙ where n is from 1 to 5, preferably n is 2), calcium acetate hydrate (i.e. CaOAc·H₂O), calcium lactate hydrate (e.g. pentahydrate), and calcium glycerophosphate. More preferably, the metal salt is calcium chloride hydrate, such as calcium chloride dihydrate.

The pH may affect the solubility of the metal salt. In some embodiments, the metal salt may have a solubility of at least 10 mM in water at 20° C. and pH 7, preferably at least 100 and preferably at least 200 nM in water at 20° C. and pH 7.

Low- or in-soluble metal salts may be used in combination with a hydrolysing agent such as a slow hydrolysing or slow releasing acid e.g. a GDL or fat-coated acid.

In some embodiment, the amount of divalent cation, preferably calcium, in the beverage is at most 0.06 wt %, for example at most 0.04 wt % and preferably at most 0.03 wt % based on the total weight of the beverage.

In some embodiments, the amount of divalent cation, preferably calcium in the beverage is at least 0.001 wt %, for example at least 0.003 wt % for example at least 0.006 wt % or example at least 0.01 wt % and preferably at least 0.02 wt % based on the total weight of the beverage.

In some embodiment, the amount of divalent cation, preferably calcium in the beverage is within a range taken from any of the upper and lower limits described above. For example, the amount of divalent cation, preferably calcium in the beverage may be from 0.001 to 0.06 wt %, preferably from 0.01 to 0.04 wt % based on the total weight of the beverage.

In this way, the fluid gel exhibits good physical properties for beverages such as low viscosity whilst maintaining the ability to suspend particles, even after heat treatment. In particular, it is believed that at the abovementioned divalent cation content range, the amount of cross-linking formed between the divalent cation and gellan is optimal such that the fluid gel has optimised viscosity and remains stable after heat treatment. Without wishing to be bound by theory, it is believed that at lower concentration of divalent cation, in particular calcium, the amount of crosslinking is low, leaving gellan in the bulk aqueous liquid which increases viscosity and when the content of divalent cation, preferably calcium is higher the binding sites are saturated and so crosslinking is less efficient.

In some embodiments, the other beverage component may include divalent cation, in particular calcium and so additional divalent cation, in particular calcium does not need to be added. For example, if the beverage comprises milk or plant-based milk (e.g. oat milk) as aqueous liquid or other dairy ingredients that contain the required level of calcium, calcium does not need to be further added to provide a beverage of the present invention.

### Process

The present invention also provides a process for producing a heat-treated beverage of the invention.

The process to produce a heat-treated beverage comprising a fluid gel comprising the steps (preferably in order) of:
1. providing a heated beverage mixture comprising gellan, divalent cation and an aqueous liquid, wherein the beverage mixture comprises 0.001 to 0.1 wt % divalent cation based on total weight of the beverage,
2. cooling while shearing the heated beverage mixture to form a cooled beverage comprising a fluid gel comprising particles formed of the gellan and the divalent cation,
3. heat-treating the cooled beverage comprising a fluid gel to obtain a heat-treated beverage comprising a fluid gel, in particular a heat-treated beverage comprising a fluid gel comprising particles formed of gellan and divalent cation.

The heat-treating step (step 3 above) may be a pasteurization or UHT heat treatment. In some embodiments the heat-treating step may involve heating the beverage mixture at a temperature of from 80 to 145° C., preferably from 100 to 140° C. and even more preferably from 120 to 140° C.

In some embodiments, the heat-treating step (step 3 above) may involve heating for at least 2 seconds, preferably at least 3 seconds, for example around 5 seconds. In some embodiments, the heat-treating step may involve heating for at most 90 seconds, preferably at most 40 seconds, more preferably at most 30 seconds, even more preferably at most 7 seconds.

The step of providing a heated beverage mixture (step 1 above), may comprise heating the beverage mixture from 60 to 90° C., preferably from 70 to 80° C. The heating may be carried out before or after calcium is added to the beverage mixture. The heating step may be carried out before or after gellan is added to the beverage mixture. Preferably the aqueous liquid is heated, then gellan is added and subsequently calcium is added before the shearing step (step 2) is performed. During the heating step, gellan may be hydrated.

The shearing step (step 2 above) is preferably carried out at high shearing speeds. For example, the shearing rate may be 400 to 10,000 rpm, preferably from 500 to 800 rpm or from 4000 to 8000 rpm. The shearing step may also be carried out by shearing through a nozzle.

The cooling (step 2 above) may be carried out at temperatures from 80 to 90° C. down to 15 to 25° C., such as cooling from 60 to 70° C. down to 18 to 22° C.

Different shearing methods and different rates of cooling can be used to adjust the particle size of the fluid gel. It has been found that the gellan based fluid gels of the invention are surprising heat stable for the various particle sizes produced.

Additional beverage components not mentioned in step 1 above may be added at any point during steps 1 and 2. That is, additional beverage components may be added after the fluid gel is formed (i.e. after step 2) before the heat treatment step (step 3).

The preferences provided above for the heat-treated beverage aspect of the invention apply equally to the process claim where relevant. For example, the amounts of gellan disclosed for the heat-treated beverage may be the same in the process.

Those skilled in the art will understand that they can freely combine all features of the present invention disclosed herein. In particular, features described for the products of the present invention may be combined with the process of the present invention and vice versa. Further, features described for different embodiments of the present invention may be combined.

Furthermore, where known equivalents exist to specific features, such equivalents are incorporated as if specifically referred in this specification. Further advantages and features of the present invention are apparent from the figures and non-limiting examples.

### Numbered Clauses

The following numbered clauses provide embodiments of the invention:
1. A heat-treated beverage comprising a fluid gel comprising particles formed of gellan and a divalent cation wherein the divalent cation is present in 0.001 to 0.1 wt % based on total weight of the beverage.
2. The heat-treated beverage of clause 1, wherein the fluid gel comprising particles formed of gellan and a divalent cation is present both before and after heat treatment.
3. The heat-treated beverage of any one of clauses 1 to 3 wherein the amount of gellan in the beverage is from 0.05 to 0.5 wt %, preferably from 0.05 to 0.11 wt % based on the total weight of the beverage.
4. The heat-treated beverage of any one of clauses 1 to 3 wherein the gellan in the fluid gel is a low acyl gellan.
5. The heat-treated beverage of any one of clauses 1 to 4 wherein the particles formed of gellan and divalent cations in the fluid gel have a particle size of 10 to 1000 μm such as from 20 to 500 μm, preferably from 30 to 100 μm
6. The heat-treated beverage of clause 5 wherein the particle size is a volume based d10 to d90 value.
7. The heat-treated beverage of any one of clauses 1 to 6 wherein the beverage has a pH of at least 4, preferably from 4 to 7.
8. The heat-treated beverage of any one of clauses 1 to 7 wherein the beverage has a viscosity in the range 100 to 15,000 mPa·s, such as 1,000 to 10,000 mPa·s measured at a shear rate of 0.1 1/s.
9. The heat-treated beverage of any one of clauses 1 to 8 wherein the beverage has a viscosity in the range 1 to 1000 mPa·s, such as 10 to 1000 mPa·s measured at a shear rate of 100 1/s.
10. The heat-treated beverage of any one of clauses 1 to 9 wherein the beverage has a PhiTau from 4 to 75 Pa, preferably from 20 to 60 Pa as measured according to the BRUCE protocol in the examples.
11. The heat-treated beverage of any one of clauses 1 to 10 wherein the fluid gel particles consist entirely of gellan and the divalent cation.
12. The heat-treated beverage of any one of clauses 1 to 11 wherein the fluid gel particles do not contain any other gelling agents different from gellan.
13. The heat-treated beverage of any one of clauses 1 to 12 wherein the divalent cation is a divalent metal cation.
14. The heat-treated beverage of clause 13, wherein the divalent metal cation is selected from calcium, magnesium zinc or a mixture thereof, preferably, the divalent metal cation is calcium (Ca²⁺).
15. A process to produce a heat-treated beverage comprising a fluid gel comprising the steps of:
   providing a heated beverage mixture comprising gellan, divalent cation and an aqueous liquid, wherein the beverage mixture comprises 0.001 to 0.1 wt % divalent cation based on total weight of the beverage
   cooling while shearing the heated beverage mixture to form a cooled beverage comprising a fluid gel comprising particles formed of the gellan and the divalent cation,
   heat-treating the cooled beverage comprising a fluid gel to obtain a heat-treated beverage comprising a fluid gel.
16. The process of clause 15 wherein the heat-treating step involves heating the beverage mixture at a temperature of from 80 to 145° C., preferably from 100 to 140° C. and even more preferably from 120 to 140° C.
17. The process of clause 15 or clause 16 wherein the shearing is carried out at a shearing rate of from 400 to 10,000 rpm, preferably from 1000 to 2000 ppm or from 4000 to 8000 rpm.
18. A heat-treated beverage comprising a fluid gel obtainable by the process of any one of clauses 15 to 17.

### Examples

In the examples below, all the concentration of calcium are expressed in terms of concentration of calcium chloride 1M.

### Methods and Materials

The methods and materials used in the examples are explained below.

### Materials

The gellan used in the examples was KelcogelF from CPKelco.

The water used in the examples was demineralized water or milliQ water.

The CaCl₂·2H2O used in the examples was obtained from Dr Paul Lohmann.

The alginate used in the examples was Alginate Vivapur FD120 from JRS.

### Shearing Apparatus

The shearing apparatus used to produce the fluid gels in the examples was either Silverson or Mondomix as detailed below.

### Silverson

For ‘Silverson’ method a laboratory mixer, Silverson LSM-A, was used with the following shear heads
Emulsor Screens (Circle head)
Slotted Disintegrating Head (Lined head)

The mixer has a double jacketed glass reactor with 400 mL volume

A hot (70° C.) sample corresponding to the relevant example was transferred from am Iso blue cap bottle into a double jacketed glass reactor. The temperature of the glass reactor was set to 15° C. by being connected to a water bath.

Immediately after transfer of the sample, the shear head of the Silverson mixer was lowered into the glass reactor at a fixed height to allowing stirring directly after addition of the sample.

The temperature was initially decreased from 70° C. to 60° C. by pouring the 200 mL sample into the glass reactor. Hence, the temperature of the sample was 60° C. once stirring was started.

Due to the double jacketed glass vessel's controlled temperature, management of the cooling rate was possible. The cooling rate was recorded using a digital thermometer. The position of the thermometer probe in the sample remained fixed.

Stirring was continued at a rate of 4000 to 6000 rpm until the temperature reached 21-22° C. (the lowest temperature possible to obtain with the 15° C. double jacketed vessel within a reasonable time period).

Finally, the sample was returned to Iso blue cap bottle for storage and further analysis. The set-up of the system remained fixed to ensure a higher level of reproducibility.

### Mondomix—Pin Stirrer

For the ‘Mondomix’ method, hydration of the gelling agent was performed at 85° C. with an Ystraal mixer X50 stirring the relevant sample containing aqueous fluid and gelling agent at 1200 rpm.

Once hydrated (typically around 5 minutes under the heating conditions), calcium chloride (1M) solution was added and the mixture was pumped through silicon tubing to a Mondomix UA-05 pin stirrer. The Mondomix is equipped with an axis mixing head consisting of a rotor and stator, both fitted with pins. They intermesh when rotating and provides constant shear. The liquid is mixed under controlled pressure creating a homogenous mass. The peristaltic pump remained at maximum capacity throughout production. Silicon tubes was used to connect the units of the set-up.

The temperature of the sample was maintained above the gelling point until it reached the Pin-stirrer using an isolation coat installed on the silicon tube leading the fluid from the sample bottle via the peristaltic pump to the Pin-stirrer.

The shear (in rpm) was manually controlled on the Pin-stirrer control panel at from 1000 to 2000 rpm.

The exit temperature was 17-20° C. when exiting the Pin-stirrer (Tₒᵤₜ).

Samples of produced fluid gel were collected in bottles once exiting the pin-stirring head.

### Rheology Measurements

To compare the viscosity of the fluid gel an Anton Paar Rheometer, MCR series, with a CC27 Sanded geometry was used. The shear rate applied starts from 0.01 to 300 s−1 and recorded points is 10 pts/decade at 20° C.

### PhiTau—Yield Stress Equivalent

The PhiTau value for the compositions mentioned below is measured using a method developed by the inventors, (referred to as the BRUCE method). This method provides a measure of the ability of the fluid gel to support particles. Tau refers to the yield stress and Phi to the (area) packing fraction. The PhiTau value can be readily obtained by carrying out the method described below.

In the BRUCE method, shear yield stress of a liquid/fluid gel, in particular liquid/fluid gel constituent particle, as defined herein can be measured. For this purpose, a rigid metal disc with a diameter of 20 mm and a thickness of 2 mm is attached to the end of a metal rod. A beaker containing the liquid sample to be measured is provided. The rigid metal disc is circular and attached to the end of the metal rod in the center of the rigid metal disc at an angle of 90°. The rigid metal disc is preferably made of any suitable metal, such as iron, steel (e.g. V2A or V4A), etc. The beaker is sized to provide at least a 1.5 cm space around the disk to avoid any edge effects.

The rod and disk are hung into the beaker from a balance (Mettler Toledo, Model XP404S).

The beaker containing the liquid sample is then raised upwards at a “known rate” with lifter/moving part (Standa, Model SM11981& 143753) causing the probe to pass through the liquid and the balance measures the net weight versus height. The “test speeds”/speeds of penetration are thereby set to be sufficiently slow such that the force required for penetration is independent of speed and that viscous effects can be neglected.

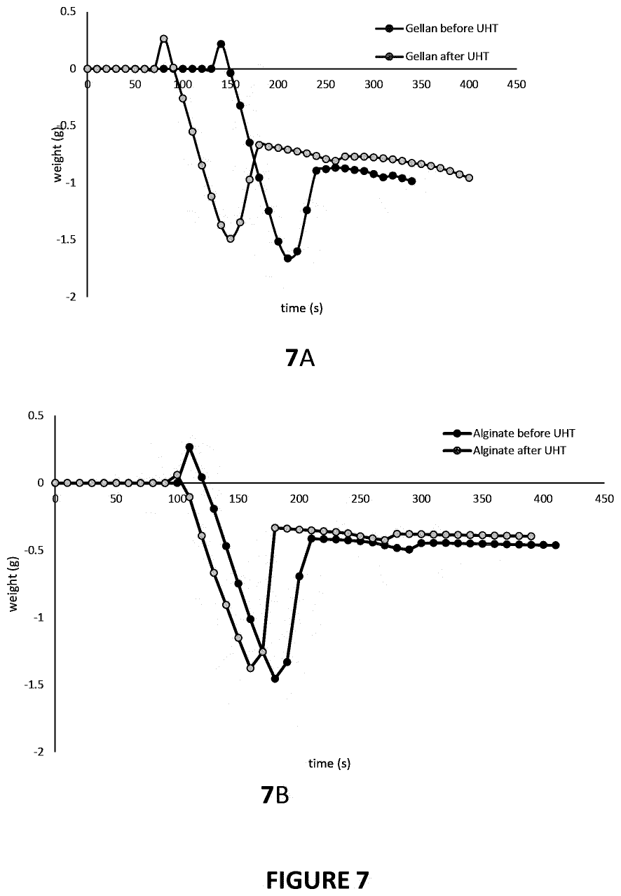

The “known rate” is identified a priori by raising the beaker with the containing the liquid sample upwards several times (e.g. 2-10 times) over a range of different “test speeds” wherein at each single “test speed” the probe is passed through the liquid sample and the balance measures the net weight versus height values. Notably, at (too) high speeds the value for the net weight versus height will increase proportionally to speed due to viscous effects. If the speed is chosen sufficiently slow, the penetration force (weight) is, however, independent from speed, since viscous effects are per definition inherently rate dependent. Such a sufficiently slow speed can then be identified from those tests using single “test speeds”, at which the penetration force (weight) reaches a “steady state” or “quasi steady state” value over time (see e.g. in FIG. 7A force (weight) at about 250-300 s, or FIG. 7B force (weight) at about 220-250 s). This sufficiently slow speed is then considered for the BRUCE measurement for the purposes of the instant invention as a threshold maximum value and represents the “known rate”. This speed is considered independent of viscous effects. The “known rate” can then be used to determine the amount of force (weight) at the “steady state” or “quasi steady state” value of the liquid sample to be measured.

Corrections for surface tension and Archimedes forces acting on the disc and that add to the amount of force (weight) due to the yield stress in grams need to be made. Thereby, control of disc thickness allows minimisation of the Archimedes force relative to the yield stress contribution. Corrections are expressed as amount of force (weight).

Such correction values can be identified by repeating the same experiment as above at the “known rate” but using a control liquid. Such a control liquid is preferably a sample that is chemically as close as possible to the fluid gel system to be measured, such that preferably exhibits the same or similar bulk density, the same or similar continuous fluid phase viscosity and wetting/surface tension as the initially measured liquid. A suitable control in the current case is e.g. a sample with MilliQ water, if the initially measured liquid was prepared e.g. by using gellan gum at the chosen concentrations and MilliQwater. Alternatively, e.g. an ungelled pore fluid (in MilliQ water) may be used. As before, the penetration force (weight) is determined at the “steady state” or “quasi steady state” value of the control liquid over time and serves as a baseline measurement: Said baseline measurement can be used for correction of the penetration force (weight) obtained for the initially measured liquid. The correction then simply requires subtraction of the baseline measurement from the penetration force (weight) of the system of interest. If measurement of a liquid to be measured yields a penetration force (weight) value of e.g. −1.2 g and the baseline measurement using the control yields a penetration force (weight) value of e.g. −0.4 g, the corrected value is −(1.2 g−0.4 g), which is −0.8 g.

Since the disc pushes through the static bed of sedimented fluid gel particles, the (corrected) penetration force (weight) measured can then be related to the compressional yield stress of the sedimented fluid gel particles. For this, the equivalency of yield stress projected over the area of the disk=π r² phi tau to the net force on the disk (the measured weight difference 0.8 g in the current example) to calculate the phi.tau value (φτ). Phi.tau (φτ) is the convolution of the bulk yield stress of the gelled particles and the surface area fraction occupied by the gel particles.

This method provides a measure of the true yield stress of the gel material forming the microgel particles in contrast to shear rheometry, which measures the shear stress acting between gel particles.

As a pure example, phi.tau (φτ) for water is determined for purposes of illustration:

Considering that:

$${R}_{d} = 0.01 m$$

$${R}_{r} = 0.001 m$$

$$d = 0.001 m$$

$$Rf = 1000 kg / {m}^{3}$$

$$g = 9.8 m / {s}^{2}$$

$$σ = 0.073 kg / {s}^{2}$$

wherein Rd is disc diameter, Rr is radius of the rod supporting the disc, d is the thickness of the disk, Rf is the ‘rho fluid’, i.e. the fluid density of the sample being tested, g is gravitational acceleration, and s is ‘sigma’, i.e. the surface tension of the test fluid in air;

the following applies:

$$V = π {r}_{d}^{2} d + π {r}_{r}^{2} h = 3.14 \times {10}^{- 7} + 3.14 \times {10}^{- 6} h$$

$$h << 1 m , so$$

$$V \approx 3.14 \times {10}^{- 6}$$

It follows that:

$$Archimedes = {ρ}_{f} g V = 0.003 N$$

$$Surface {Tension}^{*} = 2 p {r}_{d} σ = 0.00045 N$$

$$Gel stress = π {r}_{d}^{2} ϕ τ = 0.000314 ϕ τ$$

$$Balance force = w = - 0.38 g = - 0.0038 N ( as obtained via BRUCE measurement , force ( weight ) )$$

$$and$$

$$Archimedes + gel stress + balance force = surface tension$$

$$gel stress = surface tension - Archimedes - balance force$$

$$then$$

$$ϕ τ = 3.75 Pa$$

$$( {}^{*} Use Rr instead of Rd for steady state when disc is fully wetted )$$

As a pure example, phi.tau (φτ) for a gel is determined for purposes of illustration:

Considering again that:

$${R}_{d} = 0.01 m$$

$${R}_{r} = 0.001 m$$

$$d = 0.001 m$$

$$Rf = 1000 kg / {m}^{3}$$

$$g = 9.8 m / {s}^{2}$$

$$σ = 0.073 kg / {s}^{2}$$

wherein Rd is disc diameter, Rr is radius of the rod supporting the disc, d is the thickness of the disk, Rf is the ‘rho fluid’, i.e. the fluid density of the sample being tested, g is gravitational acceleration, and s is ‘sigma’, i.e. the surface tension of the test fluid in air;

the following applies:

$$V = π {r}_{d}^{2} d + π {r}_{r}^{2} h = 3.14 \times {10}^{- 7} + 3.14 \times {10}^{- 6} h$$

$$h << 1 m , so$$

$$V \approx 3.14 \times {10}^{- 6}$$

It follows that:

$$Archimedes = {ρ}_{f} g V = 0.003 N$$

$$Surface {Tension}^{*} = 2 p {r}_{d} σ = 0.00045 N$$

$$Gel stress = π {r}_{d}^{2} ϕ τ = 0.000314 ϕ τ$$

$$Balance force = w = 1.2 g = - 0.0038 N ( as obtained via BRUCE measurement , force ( weight ) , for simplicity of this illustration , no corrected value was inserted )$$

$$and$$

$$Archimedes + gel stress + balance force = surface tension$$

$$gel stress = surface tension - Archimedes - balance force$$

$$then$$

$$ϕ τ = 50.8 Pa$$

$$( {}^{*} Use Rr instead of {R}_{d} for steady state when disc is fully wetted )$$

The BRUCE method is preferably carried out at 20° C. Accordingly, phi.tau or PhiTau (φτ) values as defined herein are measured at 20° C., if not defined otherwise.

As an alternative to the above cited corrections, it might be considered, as correction, to subtract the PhiTau value measured for the reference fluid from the PhiTau value measured for the test fluid. By doing so, it becomes possible to eliminate the need for knowing the surface tension (s) and density (Rf) values of the fluids.

### Microscopy—Particle Size

The sample to be measured was prepared as follows: in a 15 ml Falcon tube, add 9 ml Milli-Q water, 0.5 ml fluid gel sample and 150 μl toluidine blue 1%.

6-9 images were taken using a Axioplan microscope, images comprising between 2 to 40 particles depending on the particle size and the magnification.

The largest dimension of 2 to 5 particles in the image is determined by eye using a scale bar and a mean average is calculated. The largest dimension is measured on 5 particles if the image comprises at least 5 particles while the largest dimension is measured on all particles of the image, if the image comprises 2-4 particles.

### Heat Treatments

The fluid gels were subjected to various heat treatments to study their stability based on the following protocols.
Pasteurization 90° C. for 30 sec
Direct steam UHT 140° C. for 5 sec
Indirect UHT 140° C. for 5 sec

Pasteurization and UHT treatment were carried out using a HT320 series UHT/HTST Pilots OMVE ‘Sterilizer in-line UHT/pasteurization’ equipment or HT122 Bench-Top Sterilizer OMVE ‘Sterilizer in-line UHT/pasteurization’ equipment.

### Example 1—Fluid Gel Preparation

Fluid gels used in the examples were prepared using the following protocol. A solution of gellan in water was heated to 70 to 80° C. The amount of gellan varies depending on the experiment from heating of gellan solution 0.0375 to 1 wt % based on total weight of the solution.

A 1M solution of CaCl2.2H2O was added to the gellan solution at 70 to 80° C. The amounts of the calcium containing solution again varies depending on the experiment.

The resulting mixture was cooled down under shear. The apparatus used to apply the shear varies depending on the experiment.

### Example 2—Shearing Methods

A study of the effect of shearing rate and shearing method was carried out. In the study, the amount of gellan was 0.1 wt % and 0.05 wt % calcium chloride (1M) was used.

6 different shearing heads were studied using the Silverson shearing method above.

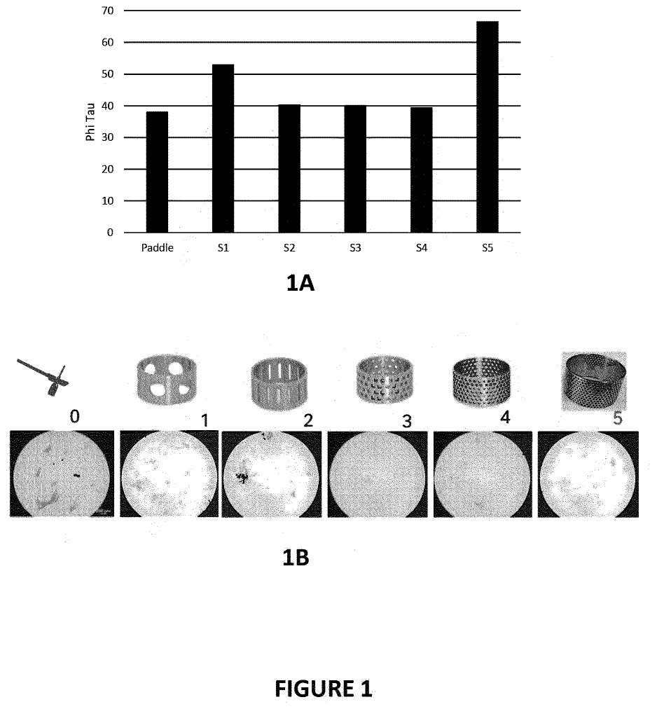

The PhiTau value for each different shearing head was measured using the BRUCE method outlined above. The results of the BRUCE tests are shown in FIG. 1A. S1 is FIG. 1A referred to the head labelled ‘1’, S2 is labelled ‘2’. The head labelled ‘0’ in FIG. 1B is a paddle and the BRUCE test result for this shearing head is the left most bar on the chart in FIG. 1A. The results show the impact of paddle and different Silverson heads on the yield stress of fluid gel particles.

The particle size for each different shearing head was measured as outlined about. The results are shown in FIG. 1B. The results show that smaller shearing heads give thinner and stiffer particles.

### Example 3—Calcium Content Study

In this study, the hydrocolloid concentration was chosen to remain liquid-like and acceptable for a beverage. As a result, the following concentrations were used:
0.1 wt % for gellan based on total weight of the composition
0.25 wt % for alginate based on total weight of the composition

The effect of varying the amount of calcium was studied. A range of fluid gels with the above amounts of gelling agent (gellan or alginate) and varying amounts of calcium were prepared. The fluid gels were prepared using the Silverson method outlined above and shearing head 5 from example 1.

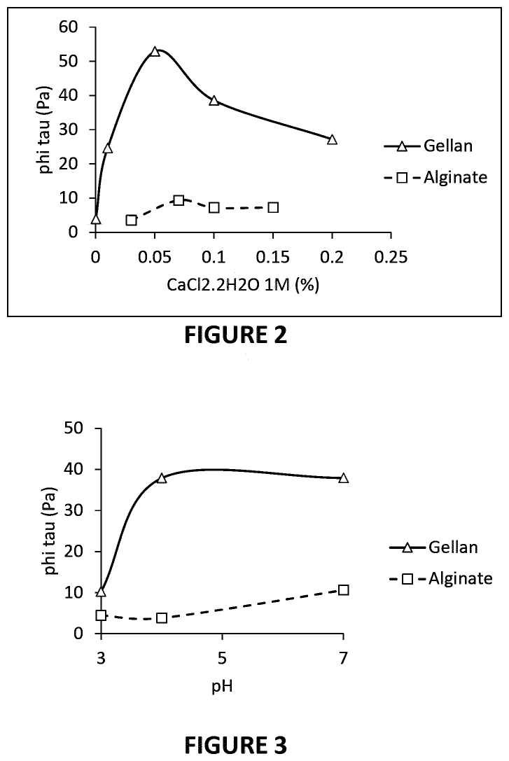

Bruce measurements as described above were carried out on each composition and the results are shown in FIG. 2. The results show that low Ca concentrations have very low PhiTau values and higher viscosities. It is proposed that this is due to low crosslinking. Higher Ca concentration provides a decrease in PhiTau and viscosity. It is proposed that this is due to lower efficiency in crosslinking and the saturation of binding sites.

The measurements show an intermediate range of calcium concentration with optimum properties. It is proposed that in this range there is a good balance of calcium and gellan so that crosslinking of the network is optimized.

In general, the Gellan has a much higher PhiTau than alginate. This suggests that gellan is more efficient at forming fluid gels than alginate.

### Example 4—pH Study

In this study, the hydrocolloid concentration was chosen to remain liquid-like and acceptable for a beverage. As a results the following concentrations were used:
0.1 wt % gellan with 0.05 wt % calcium chloride (1M) for gellan based examples on total weight of the composition.
0.25 wt % alginate with 0.07 wt % calcium chloride (1M) for alginate based on total weight of the composition.

The fluid gels were prepared using the Silverson method outlined above and shearing head 5 from example 1.

The effect of varying the pH on the fluid gel properties was studied. The pH of the samples was adjusted using HCl of NaOH (1M) to give samples of each type of gelling agent at pH 3, 4, and 7. The pH was measured using a pH probe at 20° C. Specifically a pH meter from VWR with model number pH110. The pH probe has an epoxy gel electrode and can measure pH and temperature.

Bruce measurements as described above were carried out on each composition and the results are shown in FIG. 3.

The PhiTau value for the gellan containing fluid gels does not vary significantly from pH4 to pH7. Below pH 4 the gellan fluid gels have much lower PhiTau values. For alginate, the PhiTau value does not change significantly from pH3 to pH 4 and then increases from pH4 to pH 7.

It is theorized that optimum Ca binding is obtained when carboxylic groups are deprotonated such as when pH>pKa. By zeta potential measurements, the estimated pKa to be for gellan is around 3-3.5 and for alginate it is around 4.

### Example 5—Heat Treatment Study

In this study, the hydrocolloid concentration was chosen to remain liquid-like and acceptable for a beverage. As a result the following concentrations were used:
0.1 wt % gellan with 0.05 wt % calcium chloride (1M) for gellan based examples on total weight of the composition
0.25 wt % alginate with 0.07 wt % calcium chloride (1M) for alginate based on total weight of the composition

The effect of different heat treatments on these fluid gels was studied. The fluid gels were prepared at pH's of the gelling agent in water: pH 5.5 for gellan and pH 6.5 for alginate.

For some heat treatment experiments, the fluid gels were prepared using the Mondomix method with a shear rate of 1000 to 2000 ppm and cooling to 17 to 20° C.

For other heat treatment experiments, the fluid gels were prepared using the Silverson method as described above using head 5 from Example 1.

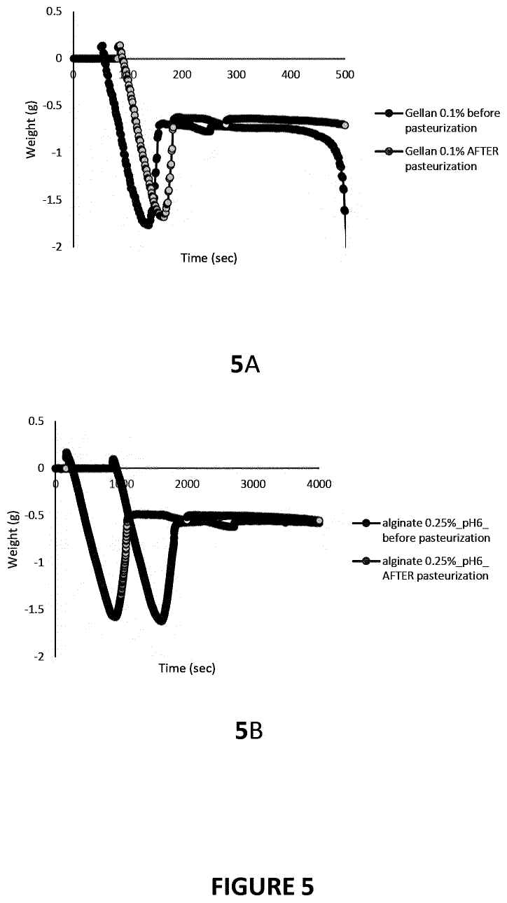

In a first set of heat treatment experiments, a sample of each of the fluid gels (gellan and alginate) produced using the Mondomix protocol above was subjected to a pasteurization treatment as outline above. The viscosity and PhiTau of the fluid gels were measured before and after the pasteurization treatment. The results are shows in FIG. 4 and FIG. 5 respectively.

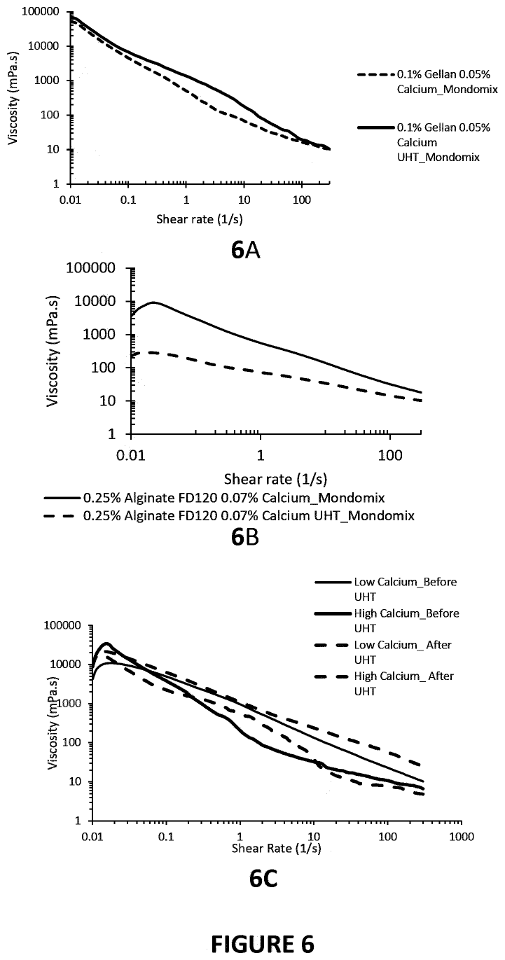

In a second set of heat treatment experiments, a sample of each of the fluid gels (gellan and alginate) produced using the Mondomix protocol above was subjected to the direct UHT treatment as outline above. The viscosity and PhiTau of the fluid gels were measured before and after the UHT treatment. The results are shows in FIG. 6 and FIG. 7 respectively.

The results show that Gellan fluid gels retained their physical properties i.e. their yield stress, viscosity and suspension properties. On the other hand, the alginate fluid gels retained their physical properties after pasteurization but not after UHT. This was observed for different concentrations.

The same heat stability was also observed for various concentrations of gellan fluid gels prepared using the Mondomix method and heat treated under the pasteurization protocol above. The results are shown in FIG. 4A.

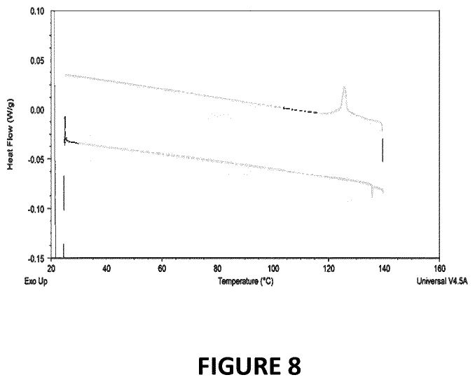

The gellan fluid gel was also studied under DSC in a mixture prepared using 0.5 wt % gellan and 0.1 wt % calcium chloride (1M). The results in FIG. 8 show that the gellan fluid gel has a melting point at about 137° C.

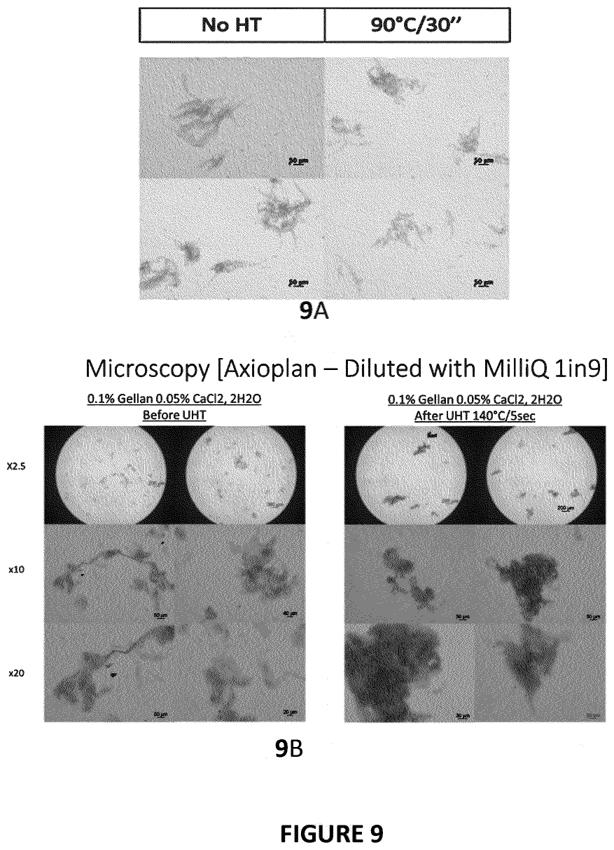

Additionally, microscopy images of the gellan fluid gels before and after pasteurization and UHT treatment were also recorded. These are shown in FIG. 9; 9A is pasteurization and 9B is UHT treatment. These images show no visual differences before and after pasteurization. For UHT treatment some visual differences are observed but the fluid gel properties such as ability to suspend particles, such as solid inclusions, and flow under high shear are maintained after the UHT treatment. That is, after UHT treatment the gellan gluid gels of the invention retain their important functional properties.

In the case of the UHT treatment, the gellan fluid gel was prepared using the Silverson method above. In the case of the pasteurization treatment, the gellan fluid gel was prepared using the Mondomix method above.

In the case of the pasteurization treatment, there is no change before and after heating. In the case of the UHT treatment, there is a small change in shape. It is proposed that this is a consequence of partial melting of the particles.

It is proposed that the optimized fluid gel parameters (amount of gellan, amount of calcium, pH, particle size etc.) of the invention gives the optimum gel strength. This is demonstrated in the PhiTau (BRUCE) measurements. Without wishing to be bound by theory, it is considered that the gels of the invention provide the most efficient packing of the gellan chains and that this can explain the surprising and unexpected heat stability of the gellan fluid gels claimed. Importantly, the gellan fluid gels of the invention are stable enough to survive UHT heat treatment conditions and maintain most of the gellan structure.

A study of heat stability of gellan fluid gels with “low” (0.01 wt %) and “high” (0.3 wt %) CaCl₂ 1M solution was carried out. The fluid gels were prepared using the Mondomix method as described above and both samples were heat treated via direct UHT treatment.

The viscosity of the ‘low’ and ‘high’ calcium content gellan fluid gels was measured before and after heat treatment. The results are shown in FIG. 6.

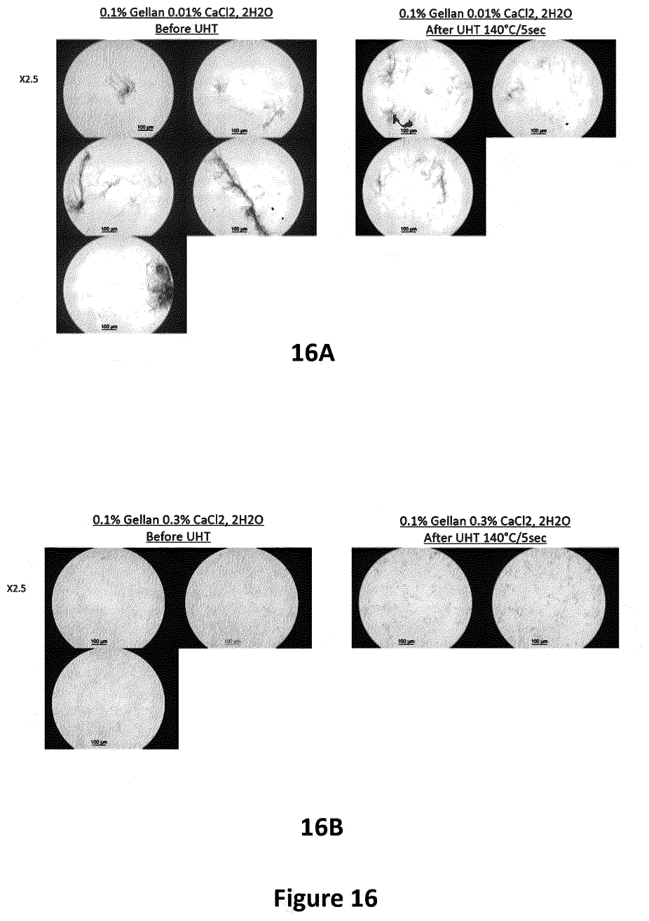

The shape of the fluid gel differs strongly between the different amount of calcium. For “low” calcium a worm-like conformation is observed; for “high” calcium much smaller particles are seen. These results are shown in FIG. 16.

### Example 6—Sensory Study

A sensory study was carried out with gellan fluid gels in water at various concentration.

A range of fluid gels were prepared as follows:
0.05 wt % gellan and 0.025 wt % CaCl₂
0.1 wt % gellan and 0.05 wt % CaCl₂,
0.2 wt % gellan and 0.1 wt % CaCl₂
0.4 wt % Xanthan gum solution—prepared by hydration of the xanthan in hot water and subsequent cooling
A broken gel—formed by breaking up a quiescently produced gel composed on 0.1 wt % gellan and 0.05 wt % calcium chloride (1M) based on total weight of the composition.

The gellan fluid gels were prepared using the Silverson method and shearing head 5 of example 1 above.

The gellan fluid gels were compared to the xanthan gel and the broken gel.

The different samples were tested by a panel of at least 8 tasters. The tasters were asked to score the thickness of the sample compared to water on a scale of 1 to 5 wherein:
0=Absent
1=Very slight
2=Slight
3=Moderate
4=Strong
5=Very strong

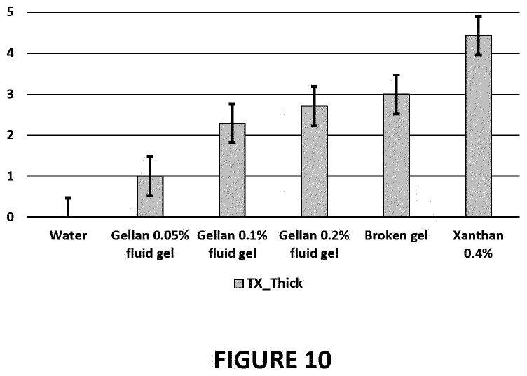

The results are shown in FIG. 10.

The gellan fluid gels were perceived as thicker than water in mouth, but less so than 0.4% xanthan gum solution which provides similar suspension properties. No particles were perceived in mouth. The thickness in mouth was expected and acceptable from a sensory standpoint.

### Example 7—Applications in Milk

Fluid gels of the invention with the ability to suspend particles were created directly in milk both with and without the addition of additional calcium ions.

A range of fluid gels were prepared in semi skimmed milk containing 2.5% fat with the 0.1 wt % or 0.05 wt % gellan and optionally with an additional 0.05 wt % calcium chloride (1M). The fluid gels were prepared using the Mondomix method above.

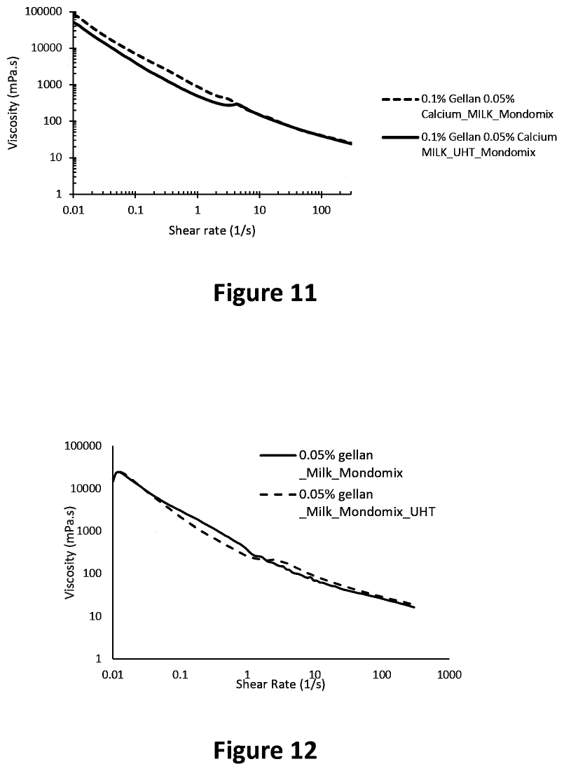

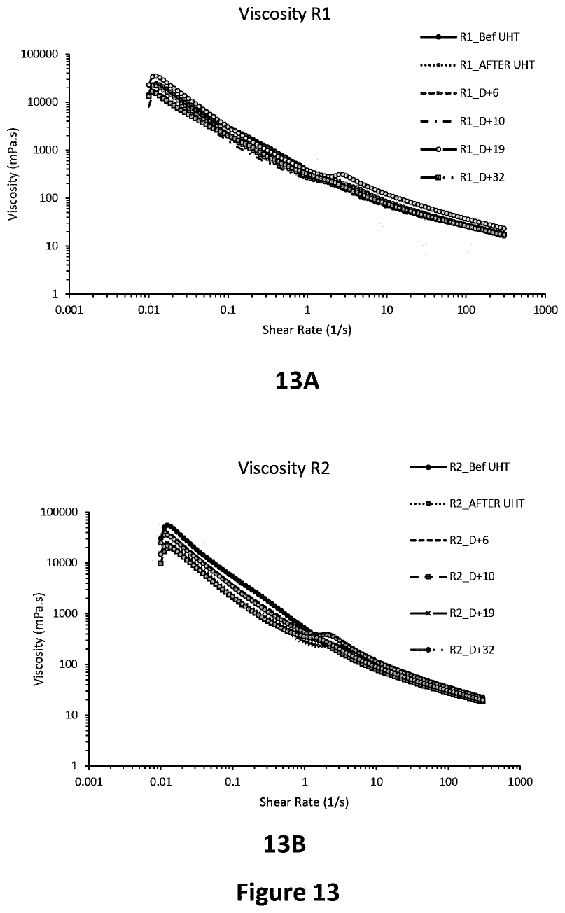

The viscosity of the fluid gels was measured both before and after UHT treatment. The results are shown in FIGS. 11 and 12.

The results show that lower gellan concentrations were needed than in water. The ability of the milk-based fluid gels to suspend particles, such as solid inclusions was retained after UHT.

The heat stability of the different milk-based fluid gels was affected differently by the heat treatment. For example, lower yield stress (PhiTau) was observed for the milk-based fluid gels in without additional calcium after UHT. There were no changes in the PhiTau (Bruce) measurements after UHT for the milk-based fluid gels containing additional Ca.

Preliminary sensory data in milk shows that no gellan particles can be felt in mouth (homogenous texture) and that higher viscosity and mouthfeel were observed in fluid gel samples compared to the corresponding non-fluid gel sample.

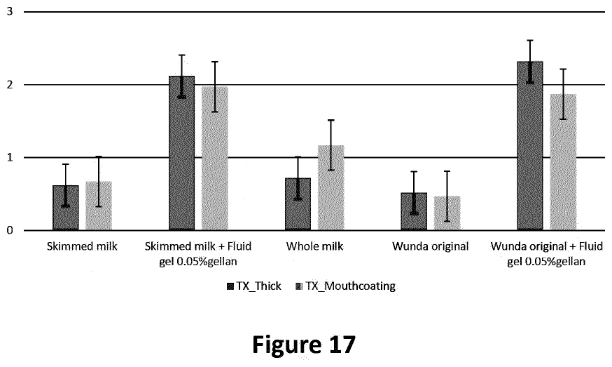

Sensory studies were conducted comparing the semi skimmed milk with fluid gels prepared as above with whole milk. The fluid gel containing semi-skimmed milk felt thicker and had a better mouthcoating than whole milk samples. As similar study was conducted for plant-based milk alternative, using a pea protein-based milk alternative of brand WUNDA (hereinafter, WUNDA milk). A gellan fluid gel was prepared using WUNDA milk as above and compared to WUNDA milk. A similar trend was observed for plant-based milk alternative, the gellan fluid gel containing WUNDA milk felt thicker and had a better mouthcoating than WUNDA milk alone. The results are shown in FIG. 17.

### Example 8—Shelf Life Study

A study of the stability of the gellan containing fluid gels over time was conducted to verify their shelf life potential. Two different gellan fluid gels were prepared in milk with and without additional calcium as follows:
R1: 0.05% gellan
R2: 0.05% gellan+0,025% Calcium chloride (1M)

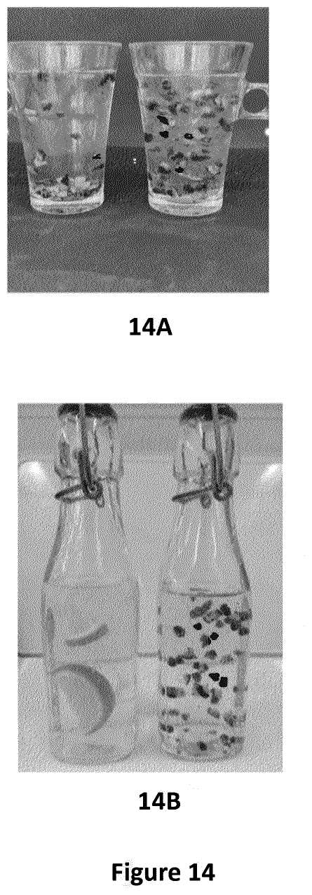

The fluid gels were made using the Mondomix method above and heat treated using the direct UHT method. The gels were tested for viscosity both before and after UHT heat treatment (carried out as outlined above). The gels were subsequently tested at various time points after storage at 4° C. The results are shown in the table below and in FIG. 14.

| | Before | After UHT | 6 | 10 | 19 | 30 |
|---|---|---|---|---|---|---|
| PhiTau | UHT | (3 days) | days | days | days | days |
| R1 | 14.2 | 12.2 | 9.51 | 12.3 | 38.07 | 27.18 |
| R2 | 19.3 | 18.1 | 12.8 | 16.0 | 31.12 | 31.2 |

### Example 9—UHT Treatment Comparative Studies

This study looks at the different properties of fluid gels treated under UHT conditions and corresponding non-fluid gel solutions that are treated under UHT conditions.

The following recipes were prepared:

| Sample | Type | Recipe | Process equipment |
|---|---|---|---|
| R1 | Pre-formed | Water + 0.1% gellan + | Mondomix then |
| | fluid gel | 0.05% CaCl₂ | UHT OMVE pilot |
| R2 | No pre-formed | Water + 0.1% gellan + | UHT OMVE pilot |
| | fluid gel | 0.05% CaCl₂ | |
| R3 | No pre-formed | Milk + 0.1% gellan | UHT OMVE pilot |
| | fluid gel | | |

For R1, the solution was processed to form a fluid gel. In particular, the fluid gel R1 was prepared with the Mondomix method above followed by UHT treatment. The UHT treatment was performed using the direct UHT method as disclosed above. After UHT treatment, the sample R1 was cooled down to room temperature.

For R2 and R3, the solution was not pre-processed to form a fluid gel before UHT treatment. In particular, the gelling agent was hydrated in water (R2) or milk (R3) at 85° C. with an Ystraal mixer X50 stirring the relevant sample containing aqueous fluid and gelling agent at 1200 rpm to obtain a mixture.

Once hydrated (typically around 5 minutes under the heating conditions), calcium chloride (1M) solution was added in the mixture for R2 (not for R3).

The obtained mixture is then UHT treated using direct UHT method as disclosed above. After UHT treatment, the samples R2 and R3 were cooled down to room temperature.

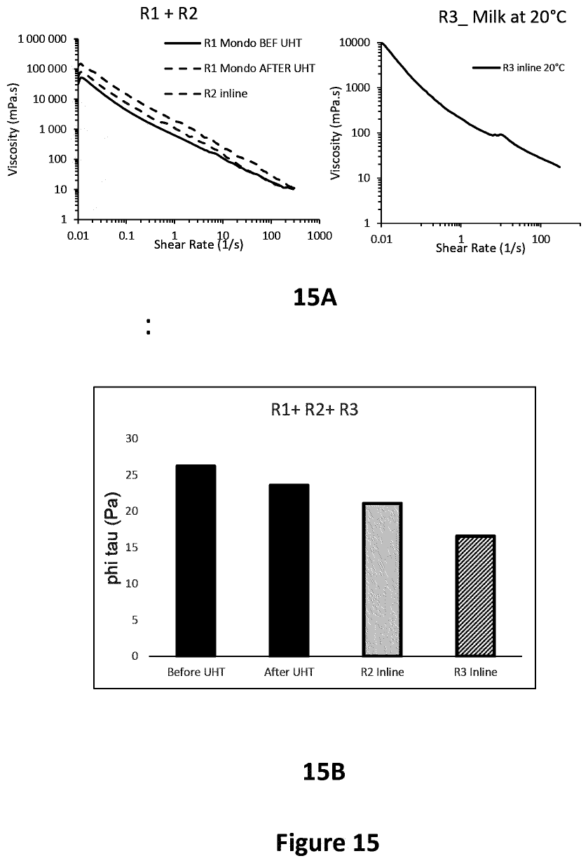

The pre-formed fluid gel presents very different Phitau values than samples that are just treated under UHT, see FIG. 15B. The viscosity is comparable, see FIG. 15A. In mouth the R2 and R3 samples felt very grainy compared to the pre-formed fluid gels prepared by Mondomix.

Viscosity profile of fluid gels produced in Mondomix before and after UHT treatment (R1, black) VS fluid gels produced in-situ in the UHT line by shearing during cooling in water (R2, grey) or in milk (R3, black).

Although the invention has been described by way of example, it should be appreciated that variations and modifications may be made without departing from the scope of the invention as defined in the claims.

1: A heat-treated beverage comprising a fluid gel comprising particles formed of gellan and a divalent cation, wherein the divalent cation is 0.001 to 0.1 wt % of the total weight of the beverage.

2: The heat-treated beverage of claim 1, wherein the fluid gel comprising particles formed of the gellan and the divalent cation is present both before and after heat treatment.

3: The heat-treated beverage of claim 1, wherein the amount of the gellan in the beverage is from 0.05 to 0.5 wt % based on the total weight of the beverage.

4: The heat-treated beverage of claim 1, wherein the particles formed of the gellan and the divalent cation in the fluid gel have a particle size of 10 to 1000 μm.

5: The heat-treated beverage of claim 1, wherein the beverage has a pH of at least 4.

6: The heat-treated beverage of claim 1, wherein the beverage has a viscosity in the range 100 to 15,000 mPa·s measured at a shear rate of 0.1 1/s.

7: The heat-treated beverage of claim 1, wherein the beverage has a viscosity in the range 1 to 1000 mPa·s, measured at a shear rate of 100 1/s.

8: The heat-treated beverage of claim 1, wherein the beverage has a PhiTau from 4 to 75 Pa as measured according to the BRUCE protocol in the examples.

9: The heat-treated beverage of claim 1, wherein the fluid gel particles consist entirely of the gellan and the divalent cation.

10: The heat-treated beverage of claim 1, wherein the divalent cation is a divalent metal cation.

11: The heat-treated beverage of claim 10, wherein the divalent metal cation is selected from the group consisting of calcium, magnesium, zinc and a mixture thereof.

12: A process to produce a heat-treated beverage comprising a fluid gel, the process comprising:
providing a heated beverage mixture comprising gellan, divalent cation and an aqueous liquid, wherein the beverage mixture comprises 0.001 to 0.1 wt % of the divalent cation based on total weight of the beverage,
cooling the heated beverage mixture while shearing the heated beverage mixture to form a cooled beverage comprising a fluid gel comprising particles formed of the gellan and the divalent cation, and
heat-treating the cooled beverage comprising the fluid gel to obtain a heat-treated beverage comprising the fluid gel.

13: The process of claim 12, wherein the heat-treating comprises heating the beverage mixture at a temperature of 80 to 145° C.

14: The process of claim 12, wherein the shearing is carried out at a shearing rate of 400 to 10,000 rpm.

15: A heat-treated beverage comprising a fluid gel obtainable by the process of claim 12.

16: The heat-treated beverage of claim 1, wherein the amount of the gellan in the beverage is from 0.05 to 0.11 wt % based on the total weight of the beverage.

17: The heat-treated beverage of claim 1, wherein the particles formed of the gellan and the divalent cation in the fluid gel have a particle size of 30 to 100 μm.

18: The heat-treated beverage of claim 1, wherein the beverage has a pH of 4 to 7.

19: The heat-treated beverage of claim 1, wherein the beverage has a viscosity of 1,000 to 10,000 mPa·s measured at a shear rate of 0.1 1/s and/or a viscosity of 10 to 1000 mPa·s measured at a shear rate of 100 1/s.

20: The heat-treated beverage of claim 1, wherein the beverage has a PhiTau from 20 to 60 Pa as measured according to the BRUCE protocol in the examples.
